(19) United States
(12) Patent Application Publication
(10) Pub. No.: US 2020/0353635 A1
(43) Pub. Date: Nov. 12, 2020

(54) MEDIA CUTTING ARRANGEMENT AND METHOD

(71) Applicant: HEWLETT-PACKARD DEVELOPMENT COMPANY, L.P., Spring, TX (US)

(72) Inventors: Martin Urrutia Nebreda, Sant Cugat del Valles (ES); Joseba Ormaechea, Sant Cugat del Valles (ES); Javier Garcia Blanco, Sant Cugat del Valles (ES); Angel Gistas Perez, Sant Cugat del Valles (ES)

(21) Appl. No.: 16/492,997

(22) PCT Filed: Jan. 30, 2018
(86) PCT No.: PCT/US2018/015885

§ 371 Date: Sep. 11, 2019

(51) Int. Cl. B26D 1/18; B26D 1/24; B41J 11/68

(52) U.S. Cl. CPC B26D 1/185; B41J 11/68; B26D 1/245

(57) ABSTRACT

A cutter arrangement for a printer is described, the cutter arrangement including a cutter module slidably arranged on a shaft, the shaft extending in a direction perpendicular to a media advance direction of the printer, wherein the cutter module comprises a movable cutting blade and a transmission group transmitting rotation of the shaft to movement of the cutting blade.

### BACKGROUND

Some printers include a cutting device which can cut a print medium before or after a printing operation. The cutting device may include a cutting blade supported on a carriage to move across a print zone. By movement of the carriage across the print zone and/or movement of the print medium along a media advance path through the print zone, the cutting blade may cut in one or two linear directions, such as the X and Y directions.

### BRIEF DESCRIPTION OF DRAWINGS

The following description references the drawings, wherein

FIG. 1 shows a perspective view of a cutting arrangement according to an example;

FIG. 2 shows a perspective view of the cutting arrangement in combination with printer parts according to an example;

FIG. 3 shows an enlarged perspective view of part of the cutting arrangement according to an example;

FIG. 4 shows a perspective view of another part of the cutting arrangement according to an example, with parts broken away;

FIG. 5 shows a different perspective view of the other part of the cutting arrangement shown in FIG. 4;

FIG. 6 shows a perspective view of a right-hand cutter module of the cutting arrangement according to an example, with parts broken away;

FIG. 7 shows a similar perspective view of a left-hand cutter module, according to an example, with parts broken away and as seen from the opposite side;

FIGS. 8 to 11 show different perspective views of a cutter module of the cutting arrangement according to an example, with parts broken away;

FIGS. 12 and 13 show different perspective views of the cutter module according to an example;

FIG. 14 is a flow diagram of a media cutting method according to an example.

### DETAILED DESCRIPTION

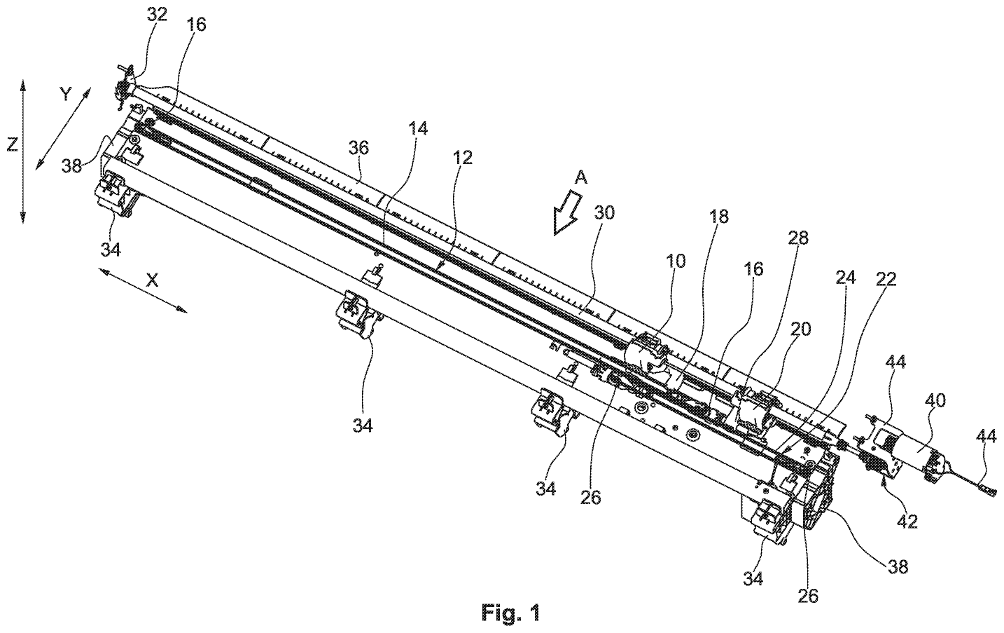

FIGS. 1, 2, and 3 provide an overview to illustrate a cutting arrangement according to an example, in different perspective views.

In the illustrated example, the cutting arrangement comprises a first cutter module 10 and a second cutter module 20. The first and second cutter modules 10, 20 are arranged on a shaft 30 extending in a direction perpendicular to a media advance direction of a printer which is illustrated by arrow A. The media advance direction A also is referred to as Y direction, and the carriage scanning direction, perpendicular to the Y direction, also is referred to as X direction. The direction of gravity, perpendicular to both the Y and X directions, may be designated as Z direction. The first cutter module 10 also can be designated as left-hand cutter module, and the second cutter module 20 also can be designated as right-hand cutter module, wherein left and right designates the position of the cutter module as seen from the front of the printer which, in this example, is the direction opposite to the media advance direction A.

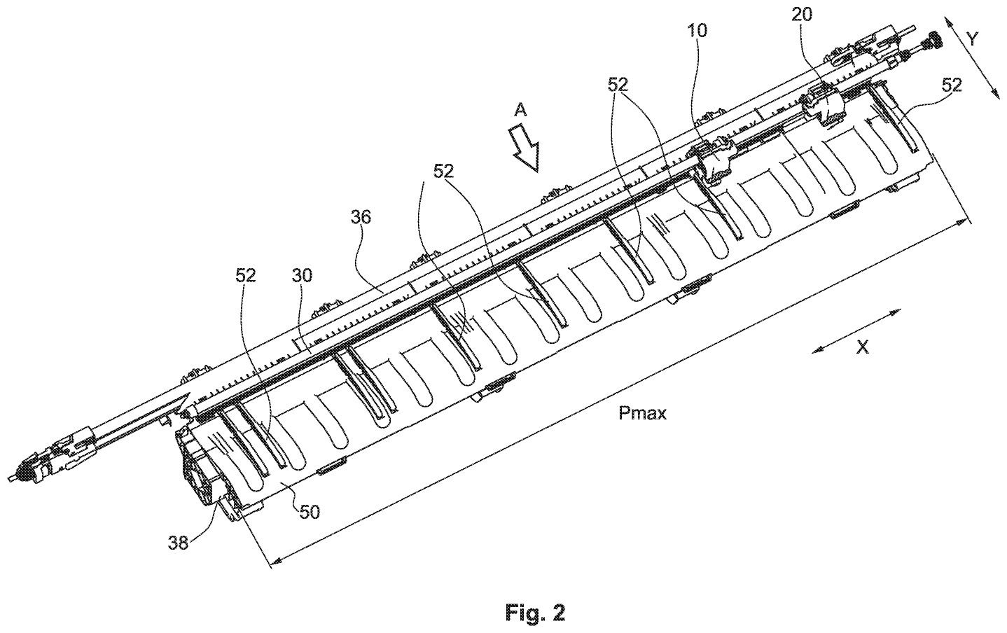

The two cutter modules 10, 20 are arranged on the shaft 30 to be independently slidable along the length of the shaft 30, e.g., along the scanning direction, wherein sliding movement of the cutter modules 10, 20 is caused by respective first and second pulley drives 12, 22 coupled to the first and second cutter modules 10, 20. This allows selectively positioning the two cutter modules 10, 20 at a right-hand edge and a left-hand edge of a cutting zone downstream of a print zone of the printer, for different cutting zones of varying width and position. In the illustrated example, a cutting zone of maximum width Pmax would extend about across the width of an output platen 50, illustrated in FIG. 2. Each pulley drive 12, 22 comprises a pulley belt 14, 24 and pulley wheels 16, 26 and drive units (not shown) for driving at least one of the pulley wheels 16, 26 of each pulley drive. A drive unit may comprise e.g. an electric motor.

In the illustrated example, pulley drive 22 associated with the second or right-hand cutter module 20 extends across about 30% of the maximum cutting zone width Pmax, at the right-hand side of the cutting zone, and pulley drive 12 associated with the first or left-hand cutter module 10 extends across about 80-90% of the maximum cutting zone width Pmax, at the left-hand side of the cutting zone. The belts 14, 24 of the first and second pulley drives 12, 22 overlap and, for example, can be designed in such a way that the first and second cutter modules 10, 20 can be positioned at any left-hand and right-hand margins of a print medium which the associate printer is able to print on in the print zone.

The first and second cutter modules 10, 20 are removably coupled to the first and second pulley belts 12, 24 by respective arms 18, 28 attached to the cutter modules 10, 20. Accordingly, movement of either one of the belts 14, 24 pulls the associated cutter module 10, 20 along the shaft 30 to position the cutter modules 10, 20 on two sides of an adjustable cutting zone, for example.

The shaft 30 is coupled to a drive motor 40 via a drive gear train 42, including a number of gears, for transmitting rotation of the drive motor 40 to the shaft 30. The drive motor 40 may be a BLDC motor or a stepping motor or another electric motor. The drive motor 40 may be supplied and driven via supply/drive lines 44 operatively coupled to a controller (not shown) of the printer, for example.

The cutter arrangement including the drive motor 40 may be mounted in a printer chassis (not shown) via a number of brackets and supports 32, 34, 36, 38, 44.

FIG. 2 illustrates the output platen 50 which may serve as support for a print medium which is transported through the printer and out of a print zone in the media advance direction A. the output platen 50 covers the pulley drives 12, 22 and the arms 18, 28 to guide the print medium on a smooth surface of the output platen 50. The cutter modules 10, 20 will be arranged above the output platen. FIG. 2 further shows a number of guide arms 52 which are provided for guiding the print medium to stay flat and even on the output platen 50 when transported in the media advance direction A. A print media advance system (not shown) may be provided to transport the print medium through the print zone and across the output platen 50 in a media advance direction A. Further, a print head (not shown) may be arranged above the print zone upstream of the output platen 50 to deposit a print fluid on the print medium within the print zone. The print head or several print heads may be carried by a printer carriage which may be slidable along a bar or a shaft (not shown) parallel to shaft 30 and extending in a direction perpendicular to the media advance direction A. The carriage may carry an array of print heads containing printing fluids, e.g. four, MCYK, ink inkjet print heads. The printing fluid may be dispensed from the print heads which may be any fluid that can be dispensed by an inkjet-type printer or other inkjet-type dispenser and may include inks, varnishes, and/or post or pre-treatment agents, for example. The carriage scans across the print medium in the print zone while the print heads are selectively fired to generate a printed plot.

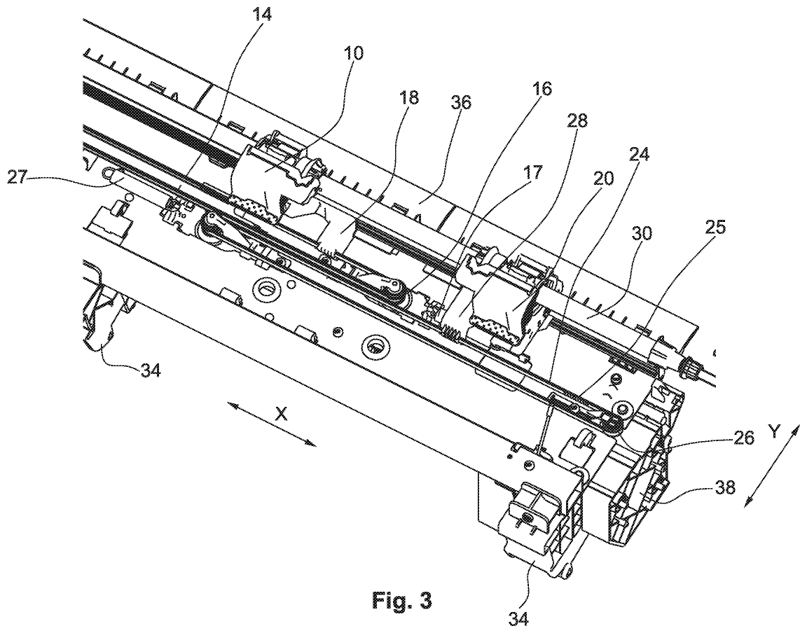

FIG. 3 allows recognizing further details of the pulley drives 12, 24, such as tensioning springs 17, 27 and a resilient portion 25 of pulley belt 24 (a respective resilient portion may be provided in pulley belt 14 but is not shown in the drawings) which allow tensioning of the pulley belts 14, 24. The pulley drives 12, 14 may be supplied and driven via supply/drive lines (not shown) operatively coupled to a controller (not shown) of the printer, for example.

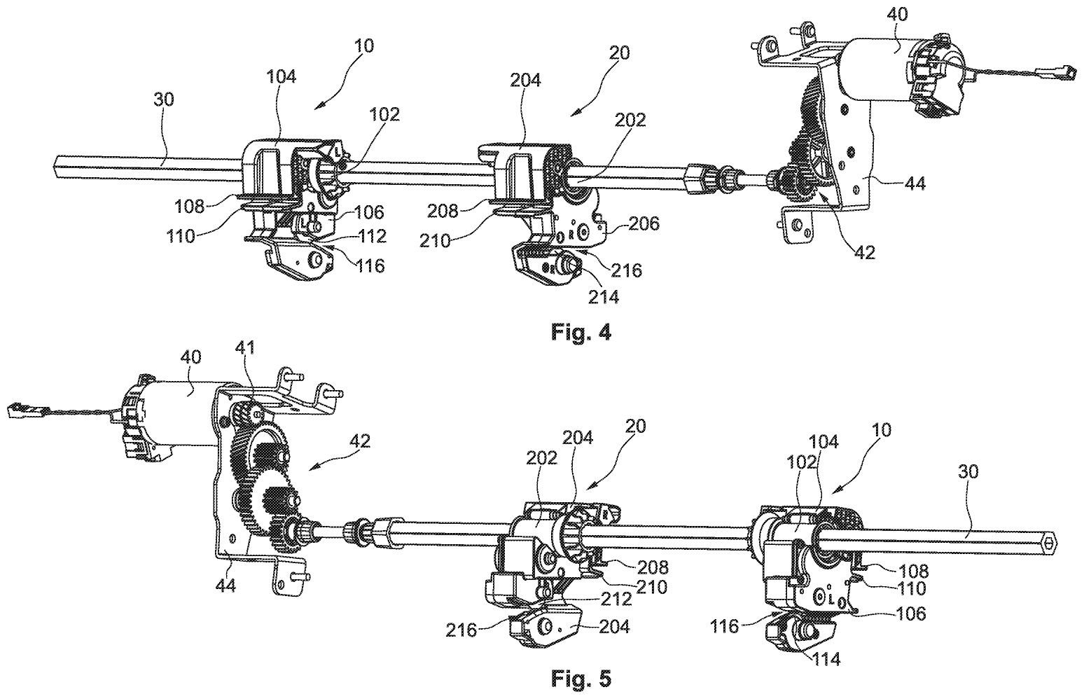

FIGS. 4 and 5 show further details of the drive gear train 42, coupling the drive motor 40 to the shaft 30, and of the coupling mechanism between the drive shaft 30 and the first and second cutter modules 10, 20. FIG. 4 is a perspective view from a similar angle as FIG. 1, and FIG. 5 is a perspective view from the opposite side of FIG. 4. The same or corresponding components as in the previous figures are designated by the same reference numbers.

In the illustrated example, the drive gear train 42 comprises a number of spur gears which, in the example, provide three transmission stages to transmit rotation of a toothed output shaft 41 of the drive motor 40 to shaft 30. The drive gear train 42 allows adjusting the rotation speed of the shaft 30 and transmits rotation of output shaft 41 in both a clockwise direction and a counterclockwise direction.

In the illustrated example, the shaft 30 has a polygonal cross-section, such as a hexagonal cross-section wherein other cross-sections, including a circular or noncircular, elliptic or a non-symmetrically shaped cross-section may be provided. The cutter modules 10, 20 are coupled to the shaft 30 by respective transmission rings 102, 202. In the example, the transmission rings 102, 202 engage with the outer periphery of the shaft 30 in a formfitting manner wherein, alternatively or additionally, a press fit or engagement by additional fixing elements, such as a screw, a bracket, adhesive or the like may be provided.

In the illustrated example, each cutter module 10, 20 comprises an upper module half 104, 204 and a lower module half 106, 206 which clamp the respective transmission ring 102, 202. In FIGS. 4 and 5, handle-like extensions 108,110, 208, 210 may be recognized to be provided at the upper and lower module halves 104, 204. These-handle-like extensions can be grabbed and pressed against each other to pivot the upper and lower module halves 108, 110, 208, 210 relative to each other to disengage the module halves from the transmission rings and unlatch the respective cutter modules 10, 20 from the transmission rings 102, 202. Accordingly, each cutter module 10, 20 can be replaced by pressing together the-handle-like extensions 108, 110, 208, 210, unlatching the cutter modules 10, 20 from the transmission rings 102, 202 and inserting another cutter module by the reverse operation.

In the example illustrated, each of the cutter modules 10, 20 comprises an upper rotary blade 112, 212 and a lower rotary blade 114, 214, which may be better recognized in the following drawings. The upper rotary blade 112, 212 is an example of a primary cutting blade and the lower rotary blade 114, 214 is an example of a secondary cutting blade. The respective upper rotary blades 112, 212 are movable cutting blades which are driven to rotate by rotation of the shaft 30, via a respective transmission group provided in the respective cutter module 10, 20. Each transmission group may have an adjustable transmission ratio. In the example, the lower rotary blade 114, 214 may be in contact with the upper rotary blade 112, 212 to be friction-driven by the upper rotary blade and to cut a print medium there between. In another example, instead of providing a lower rotary blade, a lower stationery blade may be provided, such as a knife like linear blade, which interacts with the upper rotary blade 112, 212 to cut a print medium there between. The lower stationery blade is another example of a secondary cutting blade. In another example, the upper rotary blade 112, 212 may interact with a counter surface, instead of a lower cutting blade, to cut the print medium transported across the counter surface.

In the examples, each of the cutter modules 10, 20 comprises a gap 116, 216 to guide a print medium there between and towards the associated cutting blades 112, 114, 212, 214.

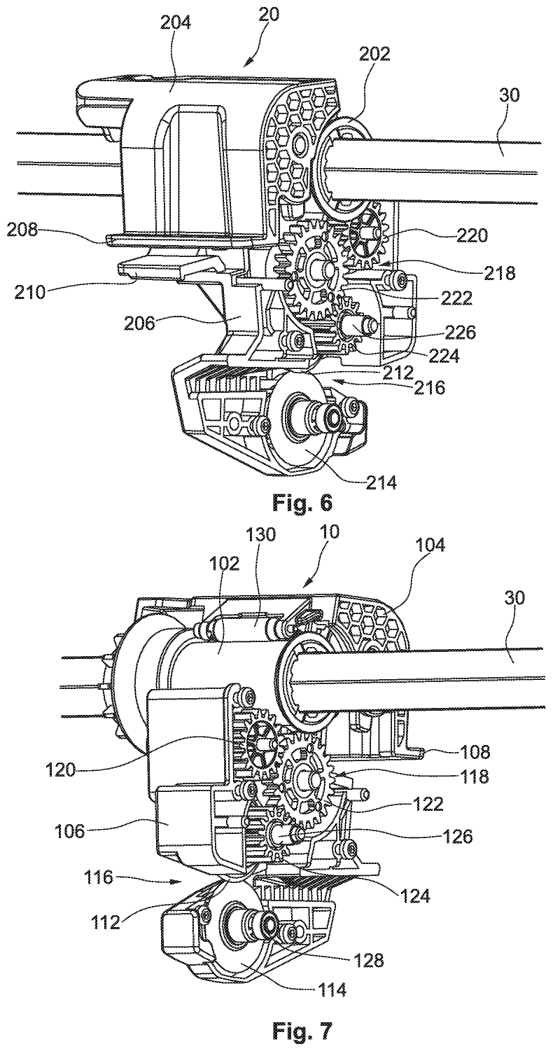

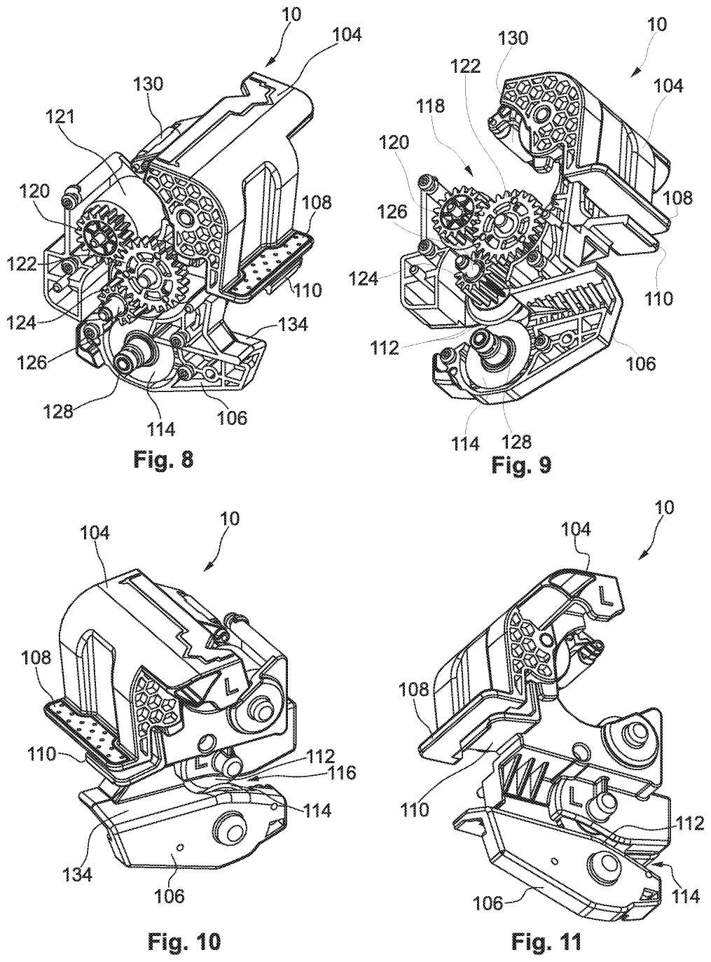

FIGS. 6 and 7 show two different perspective views, from opposite sides, of a right-hand cutter module 20 and a left-hand cutter module 10, with parts broken away to illustrate the transmission group 118, 218 between the shaft 30 and the upper rotary blade 112, 212, according to an example. The same or corresponding components as in the previous drawings are designated by the same reference numbers. Reference is made to the above description of FIGS. 1 to 5. A first gear 120, 220 comprises a cylindrical body (further illustrated in FIG. 8 with reference to the left-hand cutter module 10) which engages with the surface of the transmission ring 102, 202 to transmit rotation of the shaft 30 and the transmission ring 102, 202 to first gear 120, 220. The first gear 120, 220 meshes with a second gear 122, 222 which, in turn, meshes with a third gear 124, 224. The third gear 124, 224 is supported on a common rotary shaft 126, 226 which also carries the upper rotary blade 112, 212. Accordingly, rotation of the shaft 30 is transmitted to the upper rotary blade 112, 212 by the transmission ring 102, 202 and the gear train 118, 218. The first, second, and third gears 120, 122, 124; 220, 222, 224 can be designed to achieve a desired transmission ratio. By controlling the rotation speed of the shaft 30 and adjusting the transmission ratio, the upper rotary blade 212 can be rotated at a plurality of desired discrete rotation speeds or over a range of rotation speeds so as to cut print media at varying speeds. For example, the circumferential speed of the upper rotary blade 112, 212 can be the same as or higher than the speed at which the print medium is transported in the media advance direction A. Moreover, the rotation speed of the upper rotary blade can be adjusted according to the type of print medium, such as the thickness and/or rigidity of the print medium. For example, for a thicker and/or harder print medium a higher cutting speed may be selected then for a thinner and/or softer print medium.

In the illustrated example, the lower rotary blade 114, 214 is supported by an associated rotary shaft 128, 228 supported in the lower module half 106, 206. The lower rotary blade 114, 214 may be driven by the upper rotary blade 112, 212 by friction contact between the two blades 112, 114; 212, 214. Rotary shafts 126, 128; 226, 228 as well as respective shafts of the first and second gears 120, 122; 220, 222 may be supported in the upper and lower module halves 104, 106; 204, 206 in respective bearings, not separately described. FIG. 7 further illustrates a pinch roller 130 engaging the upper module half 104 with the transmission ring 102 in a low friction engagement.

The gear train 118, 218 is designed to rotate in one direction and to block rotation in the other direction. In the example shown, based on the perspective of FIG. 6, if the shaft 30 rotates in the counterclockwise direction, rotation will be transmitted by the transmission group 218 and the third gear 224 and hence the upper rotary blade 212 will be driven to rotate in the clockwise direction to cut a print medium which enters the gap 216. If, however, the shaft 30 rotates in the clockwise direction, the gear train 218 will lock and rotation of the shaft 30 will pivot the entire cutter module 20 from a cutting position shown in FIG. 6 into a tilted or standby position where the cutter module is moved out of the plane of print media transport. The cutter module 20 and the cutter module 10 may be pivoted around the shaft 30 e.g. in a range of 45° to 180° from the cutting position shown in the drawings to a standby position. To this end, one of the first, second, and third gears 120, 122, 124; 220, 222, 224 can be implemented as a locking gear interacting with a ratchet pawl which allows rotation in one direction but not in the other direction.

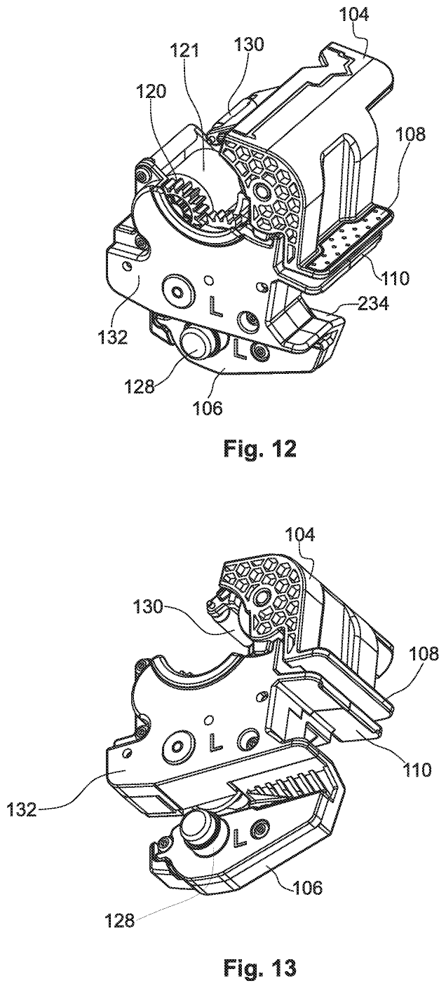

FIGS. 8 to 13 show different perspective views of the left-hand cutter module 10, wherein in FIGS. 8 and 9 parts are broken away to illustrate the transmission group 118 between the shaft (not shown in FIGS. 8 to 13) and the upper rotary blade 112, according to an example. FIGS. 8 and 9 show views from the left, FIGS. 10 and 11 show views from the right, and FIGS. 12 and 13 show similar views as FIGS. 8 and 9 but without parts broken away. The same or corresponding components as in the previous drawings are designated by the same or corresponding reference numbers. Any components of the right-hand module 20 which are designated by reference numbers starting with “2” correspond to components of the left-hand module 10 which are designated by a corresponding reference numbers starting with “1”. Reference is made to the above description of FIGS. 1 to 7.

The right-hand module 20 and the left-hand module 10 may be mirror versions of each other or may include variations. As in the right-hand module 20, the left-hand module 10 comprises a first gear 120 having a cylindrical body 121 which engages with the surface of the transmission ring (not shown in FIGS. 8 to 13) to transmit rotation of the transmission ring and hence the shaft to first gear 120. The first gear 120 meshes with a second gear 122 which, in turn, meshes with a third gear 124. The third gear 124 is located on a common rotary shaft 126 which also carries the upper rotary blade 112 of the left-hand module 10. Accordingly, rotation of the shaft is transmitted to the upper rotary blade 112 by the transmission ring 102 and the gear train 118. The first, second, and third gears 120, 122, 124 can be designed to obtain a desired transmission ratio. By controlling the rotation speed of the shaft and adjusting the transmission ratio, the upper rotary blade 112 can be rotated at a plurality of desired discrete rotation speeds or over a range of rotation speeds so as to cut the print medium at varying speeds. For example, the circumferential speed of the upper rotary blade 112 can be the same as or higher than the speed at which the print medium is transported in the media advance direction A. Moreover, the rotation speed of the upper rotary blade can be adjusted according to the type of print medium, as explained above.

In the illustrated example, the lower rotary blade 114 is supported by an associated rotary shaft 128 supported in the lower module half 106. The lower rotary blade 114 may be driven by the upper rotary blade 112 by friction contact between the two blades 112, 114. Rotary shafts 126, 128 as well as respective shafts of the first and second gears 120, 122 may be supported in the upper and lower module halves 204, 106 in respective bearings, not separately described. FIGS. 8 and 9 further illustrate a pinch roller 130 engaging the upper module half 104 with the transmission ring in a low friction engagement.

The gear train 118 is designed to rotate in one direction and to block rotation in the other direction. Reference is made to the description of FIG. 6. To achieve this effect, one of the first, second, and third gears 120, 122, 124 can be implemented as a locking gear interacting with a ratchet pawl which allows rotation in one direction but not in the other direction.

FIGS. 6 to 13 further illustrate reinforcement ribs and other reinforcement structures in the left-hand module 10 and the right-hand module 20 not described in detail here. FIGS. 12 and 13 show similar perspective views as FIGS. 8 and 9 with a cover plate 132 attached to the side of the lower module half 106.

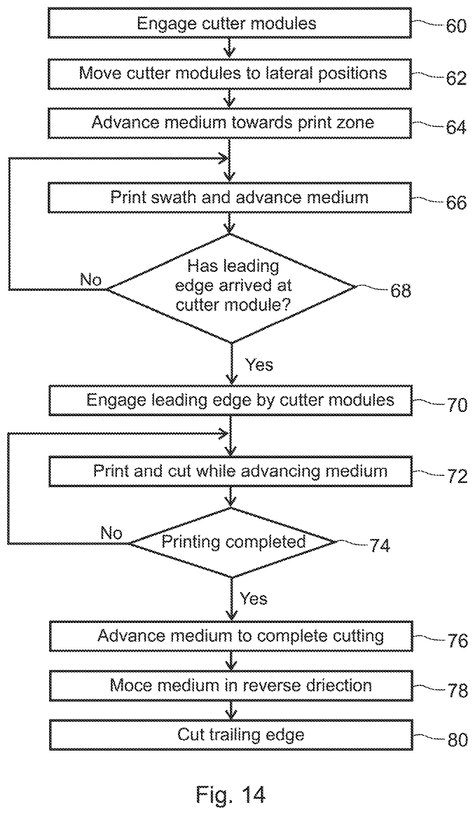

FIG. 14 shows a flow diagram of a media cutting process according to an example. The process may be performed in a printer, such as an inkjet printer, including a cutter arrangement having two cutter modules 10, 20. The process comprises engaging the cutter modules 10, 20 and the shaft, at block 60, and moving the cutter modules 10, 20 along the shaft 30 to desired lateral positions at the two sides of printing and cutting zones, at block 62. The cutter modules 10, 20 can be arranged at a distance corresponding to a to-be-cut width of a print medium. The print medium then is advanced towards a print zone of the printer, at block 64, with a leading edge of the print medium crossing the print zone in the media advance direction A. The print medium (not shown in the drawings) can be a print medium, such as a single sheet or a continuous web of print medium fed to the print zone from an input tray, a drawer or roll of paper, for example. The medium may be paper or a foil, for example. The print medium can be fed by media feed rollers which are arranged downstream and/or upstream of the print zone, by a belt or a number of belts and/or by rollers integrated into the print platen, for example.

Once the print medium has arrived at the print zone, the printer can start printing swaths of a print fluid, such as ink, and advancing the medium through the print zone, at block 66. At block 68 it is checked, whether the leading edge of the print medium has arrived at the cutter modules. If no, the printer continues to print swaths of the print fluid and advance the print medium in the media advance direction, at block 66. If the leading edge of the print medium has arrived at the cutter modules, the leading edge of the print medium can be engaged by the cutter modules 10, 20 at two opposite sides of the print zone, at block 70, and the process can continue with printing on and cutting the print medium while advancing the printing medium, at block 72. The leading edge of the print medium can enter the gaps 116, 216, near side edges of the print medium, to come into contact with the cutting blades 112, 114, 212, 214, at which point in the process the cutting blade start cutting into the print medium. If the circumferential speed of the rotary blades 112, 114, 212, 214 is higher than the media advance speed, rotation of the rotary blades 112, 114, 212, 214 can create a tensioning effect which pulls the print medium in the media advance direction so that the print medium is held flat and tensioned, improving the cutting performance. Concurrent with the cutting operation 64, printing on the print medium may be performed.

The cutting blades may be aligned to a direction parallel or substantially parallel to the media advance direction A. The cutting blades alternatively may be aligned to a direction which includes a small angle with the media advance direction A, such as an angle of about 0.5° to 5° to the media advance direction A. Accordingly, when the cutting blades rotate, due to their slightly oblique arrangement, they pull the medium in the media advance direction A but also apply a small pulling component towards the outside of the plot in the scanning direction X. The cutting blades are arranged in such a manner that the left-hand cutter module 10 pulls to the left and right hand cutter module 20 pulls to the right, as seen from the front of the printer. This tensions the medium to be cut and removes bubbles of the medium between both cutter modules.

The print medium continues to be advanced in the media advance direction A, with repeated printing and cutting operations, as long as the printing process is not completed. Printing on the print medium in the print zone and cutting the two opposite side edges of the print medium in the media advance direction can be performed simultaneously in what may be considered a single operation. It also can be performed intermittently.

The cut-off margins of the print medium, to the left and right of the print zone, can be deflected towards the two sides along a guide surface 134, 234 of the lower module halves 106, 206, wherein the guide surface 134 is best seen in FIG. 10.

At block 74 it is checked whether printing is completed. If yes, the print medium can be moved further in the media advance direction to complete cutting down to the end or trailing edge of the plot, at block 76. The print medium then can be moved in the reverse direction, i.e. in a direction opposite to the print media advance direction A, by a defined distance, at block 78, and a trailing edge of the print medium can be cut in a direction transversing the media advance direction A, e.g. in a direction perpendicular to the media advance direction A, the perpendicular direction also referred to as scanning direction X, at block 80. Cutting of the print medium in the transverse direction may be performed by a separate X-direction cutting device which can be arranged for cutting a leading edge and/or a trailing edge of the print medium at an entry side or an exit side of the print zone.

In the example, the cutter modules 10, 20 are arranged downstream of the X-direction cutting device, as seen in the media advance direction A. Therefore, when printing and cutting is completed in the media advance direction A, or Y direction, the trailing edge of the print medium is moved backwards to be cut by the X-direction cutting device.

Drive of the print media advance system (not shown), the shaft 30 and pulley drives 12, 22 of the cutter modules 10, 20 as well as other entities of the printer and an associated cutting equipment may be controlled by a controller (not shown). The controller can be a microcontroller, ASIC, or other control device, including control devices operating based on hardware or a combination of hardware and software. It can include an integrated memory or communicate with an external memory or both. The same controller or separate controllers may be provided for controlling carriage movement, media advance and the rotary actuator. Different parts of the controller may be located internally or externally to a printer or separate cutting device, in a concentrated or distributed environment.

1. A cutter arrangement for a printer, the cutter arrangement including a cutter module slidably arranged on a shaft, the shaft extending in a direction perpendicular to a media advance direction of the printer;
wherein the cutter module comprises a movable cutting blade and a transmission group transmitting rotation of the shaft to movement of the cutting blade.

2. The cutter arrangement of claim 1 including a first cutter module and a second cutter module, both cutter modules separately and slidably arranged on the shaft to position the first and second cutter modules on opposite sides of a print zone of the printer.

3. The cutter arrangement of claim 2 further comprising a shaft drive group operatively coupled to the shaft to rotate the shaft.

4. The cutter arrangement of claim 3, wherein the shaft drive group comprises an electric motor and a gear train.

5. The cutter arrangement of claim 4, wherein the transmission group of the cutter module or the gear train of the shaft drive group has an adjustable transmission ratio.

6. The cutter arrangement of claim 1, wherein the cutter module comprises a clamp device to engage and disengage the cutter module with/from the shaft.

7. The cutter arrangement of claim 1, wherein the cutter module comprises a primary rotary cutting blade and a secondary cutting blade, the primary and secondary cutting blades interacting to cut the print medium there between.

8. The cutter arrangement of claim 7, wherein the secondary cutting blade is a rotary cutting blade in contact with and driven by the primary rotary cutting blade.

9. The cutter arrangement of claim 7, wherein the secondary cutting blade is a stationary linear cutting blade in contact with the primary rotary cutting blade.

10. The cutter arrangement of claim 1, wherein the cutter module comprises a primary rotary cutting blade and a secondary cutting surface , the primary rotary cutting blade and the cutting surface interacting to cut a print medium there between.

11. The cutter arrangement of claim 2, wherein each cutter module comprises a gap to guide a print medium there between and towards the associated cutting blade.

12. The cutter arrangement of claim 2, further comprising a first pulley drive and a second pulley drive respectively associated with the first and second cutter modules to translate and position the first and second cutter modules along the shaft.

13. The cutter arrangement of claim 1, wherein the movable cutting blade is a rotary cutting blade and the transmission group of the cutter module comprises a locking gear which is unlocked to transmit rotation of the shaft to the rotary cutting blade when the shaft is rotating in a first direction and which is locked to pivot the cutter module from a cutting position to a standby position when the shaft rotates in a second direction, opposite to the first direction.

14. A printer including:
a platen to support a print medium in a print zone;
a print media advance system to transport the print medium through the print zone in a media advance direction;
a print head to deposit a print fluid on the print medium within the print zone;
a first cutter module and a second cutter module, both cutter modules separately and slidably arranged on a shaft, the shaft extending in a direction perpendicular to the media advance direction to respectively position the first and second cutter modules on two opposite sides of the print zone, with the print media advance system transporting the print medium in the media advance direction between the first and second cutter modules.

15. A method including
advancing a print medium towards a print zone of a printer, with a leading edge of the print medium crossing the print zone in a media advance direction;
engaging the leading edge of the print medium by cutter modules at two opposite sides of the print zone;
printing on the print medium in the print zone and simultaneously cutting two opposite side edges of the print medium in the media advance direction; and
when printing is completed, moving the print medium by a distance in a direction opposite to the print media advance direction and cutting a trailing edge of the print medium in a direction traversing the media advance direction.
